(19) United States
(12) Patent Application Publication
(10) Pub. No.: US 2002/0077906 A1
(43) Pub. Date: Jun. 20, 2002

(54) Method and system for cross-promoting products or services using an interactive medium

(76) Inventor: Dillon Remler, Hull, MA (US)

Correspondence Address: MINTZ, LEVIN, COHN, FERRIS,, GLOVSKY and POPEO, P.C., One Financial Center, Boston, MA, 02111, US

(21) Appl. No.: 09/935,786

(22) Filed: Aug. 22, 2001

Related U.S. Application Data
(60) Provisional application No. 60/227,425, filed on Aug. 23, 2000.

(51) Int. Cl. G06F 17/60

(52) U.S. Cl. 705/14

(57) ABSTRACT

A method and system for advertising or promoting the products or services of one or more sponsors includes presenting to a consumer a plurality of interactive presentations. Each interactive presentation promoting at least one product or service by at least one sponsor and each successive interactive presentation being related to at least one other presentation. Each presentation can further request input or feedback from the consumer. The interactive presentations can be related in many ways. For example, the products or services promoted in one interactive presentation can be directly related to the products or services promoted in another presentation or all of the interactive presentations or the products or services promoted therein can be related to a common theme, goal or purpose. The promotion can provide an incentive to the consumer to participate in the form of an award, prize, product giveaway or product discount.

### CROSS-REFERENCE TO RELATED APPLICATIONS

This application claims priority to U.S. Ser. No. 60/227,425 filed Aug. 23, 2000, which is incorporated herein by reference in its entirety.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention relates to a new method and system for advertising or promoting one or more products and/or services of one or more companies using an interactive capable medium and/or device, such as the Internet. More specifically, the present invention relates to a method and system for interactive cross-branding; a method and system which interacts with the consumer through a promotion and wherein the image, value or consumer desirability of a first product or service is enhanced by cross-branding or by cross-promoting it with one or more other products or services which reinforce the image, value or consumer desirability of the first product or service.

### BACKGROUND OF THE INVENTION

For decades, companies have been promoting their products or services by means of traditional advertisements directed to the consuming public's attention through the traditional media—printed (e.g., newspapers, magazines, signage, billboards) and broadcast or on-air (e.g., television and radio)—and, more recently, the Internet. These advertisements are typically concerned with promoting just one single product or service of a single advertiser or sponsor. In addition, these advertisements are static in the sense that the targets of the advertisements, i.e. consumers, need to do no more than listen to or read the advertisement as provided to them.

Companies have also used other means of promoting their products and services including such things as sweepstakes, contests, free trials, raffles, discounts and rebates. As with printed and broadcast advertisements, these product and service promotions are also typically concerned with promoting just one single product or service of the advertiser or sponsor. These types of promotions are also largely static in that consumers have to take only limited acts to be eligible to receive what is being offered by the advertiser or sponsor. Typically, the consumer's acts are limited to doing nothing more than filling out a postcard or short questionnaire, or doing the equivalent on the Internet, and returning it to the sponsor of the sweepstakes promotion or the like. In still other instances, companies promote their products or services by sponsoring an event or series of events (e.g., concerts, concert tours, sporting events). In exchange the sponsor or sponsors of the event(s) are given the right to display their logos, products/services or advertisements to those actually attending the event or those watching its broadcast. In most instances, sweepstakes and other means of promotion have a single sponsor. In some instances, multiple sponsors are involved. While these sponsors are typically selected based upon the commonality of their target audiences, these sponsors are not, however, selected on the basis of the complementary nature of their products or services. The same is also true for those rare instances in which more than one product or service is promoted in a traditional advertisement.

### SUMMARY OF THE INVENTION

The present invention is directed to a method and a system for promoting related products and/or services through an interactive presentation. In accordance with the invention, the promotion provides for interaction between the consumer and the presentation medium throughout the promotion, such as by permitting repeated input or feedback from the consumer (who interacts with the presentation). The promotion can provide an incentive for the consumer to interact with the presentation and continue to interact with the presentation. The incentive can take the form of prizes, awards and/or discounts or can be a function of the entertainment value of the presentation to the consumer. In addition, the present invention can be used to promote the products and/or services of multiple advertisers or sponsors. The products and/or services of the advertisers or sponsors can be selected because their products or services are related to each other (for example, they are complementary in nature) or because of their relation to a specific theme.

The present invention is also directed to a method for promoting a product or service comprising the steps of a) identifying a primary sponsor, b) identifying a primary product or service, c) identifying a secondary sponsor, d) identifying a secondary product or service, e) designing an interactive cross-branding promotion in which the secondary product or service enhances the image, value or consumer desirability of the primary product or service, and f) implementing an interactive cross-branding promotion. The interactive cross-branded promotion can include more than one primary sponsor, more than one primary product or service, more than one secondary sponsor, and/or more than one secondary product or service. In general, the primary sponsor or sponsors can have a greater presence within the promotion (e.g., the primary sponsor's products or services are, in the majority of the promotion's elements, presented whenever the secondary products or services are presented or the promotion will specify how the secondary product or service relates to or concerns the primary product or service) or have greater participation in the design of the promotion. In addition, the interactive cross-branded promotion can include tertiary and lesser sponsors and/or tertiary and lesser products or services. Tertiary and lesser sponsors and their products or services, typically will have lesser presence and/or participation in the promotion.

The present invention is also directed to a method for promoting a product or service comprising the steps of a) identifying a first sponsor, b) identifying a first product or service, c) identifying a second sponsor, d) identifying a second product or service, e) designing an interactive cross-branding promotion in which the second product or service enhances the image, value or consumer desirability of the first product or service, and f) implementing an interactive cross-branding promotion. The interactive cross-branded promotion can include a plurality of sponsors and/or a plurality of products and/or services that enhance the image, value or consumer desirability of any of the other products and/or services. The interactive cross-branding promotion can be designed where the first sponsor and the second sponsor (or their products or services) are presented or participate equally within the promotion or one sponsor can have a greater presence or participation within the promotion.

The present invention is also directed to a method for promoting a product or service comprising the steps of a) presenting a first interactive presentation promoting a first product or service by a first sponsor and b) presenting a second interactive presentation promoting a second product or service by a second sponsor in which said second product or service is related to said first product or service. The present invention can further include the step of presenting a third interactive presentation promoting either the first product or service, the second product or service or a third product or service that is related to the first product or service or the second product or service.

The present invention is also directed to a system or apparatus which is adapted to present a first presentation promoting a first product or service of a first sponsor that enables a consumer to interact with the first presentation and which is adapted to present a second presentation promoting a second product or service that enables the consumer to interact with the second presentation, and wherein, the first product or service and the second product or service are related to each other or to a common theme. The system or apparatus can also present a third presentation promoting either the first product or service, the second product or service, or a third product or service that enables the consumer to interact with the third presentation by either the first sponsor or the second sponsor or a third sponsor.

The present invention is also directed to a method for promoting a product or service comprising the steps of a) presenting a first interactive presentation promoting a primary product or service by a primary sponsor and b) presenting a second interactive presentation promoting a secondary product or service by a secondary sponsor in which said secondary product or service is related to said primary product or service or to a common theme. The present invention can further include the step of presenting a third interactive presentation promoting either the primary product or service, the secondary product or service or a tertiary product or service that is related to the primary product or service or to the secondary product or service or to a common theme.

The present invention is also directed to a system or apparatus which is adapted to present a first presentation promoting a primary product or service of a primary sponsor that enables a consumer to interact with the first presentation and which is adapted to present a second presentation promoting a secondary product or service that enables the consumer to interact with the second promotion, and wherein, the primary product or service and the secondary product or service are related to each other or are related to a common theme. The system or apparatus can also present a third presentation promoting either the first product or service, the second product or service, or a tertiary product or service by either the first sponsor or the second sponsor or a third sponsor.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 is a diagrammatic view of a system for providing an interactive cross-branding promotion in accordance with the present invention; and

FIG. 2 is a flow chart of a method for providing an interactive cross-branding promotion in accordance with the present invention.

### DETAILED DESCRIPTION

The present invention is directed to a method and system for interactive cross-branding. Interactive cross-branding is a method and system for promoting products and/or services which utilize an interactive capable medium and/or device (such as the Internet) and an interactive presentation of related or complementary products or services that enhance the value, image or consumer desirability of the products or services promoted through cross-promoting.

A promotion is a presentation or a series of presentations that promote a product or service and encourage a consumer to interact with the presentation or participate in the promotion. Typically, the consumer is encouraged to interact or participate through the promise of a prize, award, product giveaway or product discount. The promotion can also encourage or invite the consumer to interact or participate because the promotion or one or more of its presentations provides some entertainment or educational value to the consumer. A presentation typically includes audio, visual or audio-visual content which promotes a product or service by providing information about a product or service to the consumer through a presentation device such as a television, radio, computer, telephone, pager, PDA or similar device. Some devices, such as computers and telephones, for example, are interactive devices through which the consumer can interact and participate in the promotion. Other devices, such as televisions and radios, are not typically interactive devices and therefore interaction or participation can be provided through another device such as a computer or telephone or a customized device that provides for consumer interaction. The information presented can be an extensive description of the product or service promoted or as basic as a simple introduction of the product or service to the consumer.

In one embodiment, an interactive cross-branding promotion in accordance with the present invention can include a primary or principal product or service being promoted and one or more secondary products or services being promoted. The principle product or service being promoted in an interactive cross-branding promotion, i.e., the product or service whose value, image or desirability is to be enhanced, is known as the primary product or service. The manufacturer(s), distributor(s) or seller(s) of the primary product or service are known as the primary sponsor(s) or advertiser(s). The primary sponsor can also be the principle financier of an interactive cross-branding promotion, either by paying more than all the other sponsors or by paying the most on an individual basis. The primary sponsor can also have primary authority to determine the content of each of the presentations that make up the promotion. In addition, there can be more than one primary sponsor that jointly promote a single product or service or a set of products and/or services, for example a manufacturer and a distributor or manufacturer and a value added reseller.

The other products or services being promoted in this type of interactive cross-branding promotion are known as secondary and lesser (e.g., tertiary) products or services. The secondary and lesser products or services are specifically selected to be part of a cross-branding promotion to enhance the value, image or consumer desirability of the primary product or service. The manufacturer(s), distributor(s) or seller(s) of the secondary and lesser products or services are known as the secondary and lesser (e.g., tertiary) sponsors.

In general, the primary sponsor or sponsors can have a greater presence within the promotion, e.g., the primary sponsor's products or services are, in the majority of the promotion's elements and presented whenever the secondary products or services are presented, or the promotion will almost always specify how the secondary product or service relates to and/or enhances the value, image or consumer desirability of the primary product or service. In addition, secondary and lesser sponsors can typically participate less financially in the development and operation of the interactive cross-branding promotion than the primary sponsors and/or can have less ability to participate in the decisions concerning the design and/or development of the interactive cross-branding promotion. For example, the choice of the identity and number of secondary and lesser sponsors and their products or services can be determined solely by the primary sponsor or by the primary sponsor with input or guidance from one or more of the secondary and lesser sponsors. Alternatively, an independent design organization can chose the primary as well as the secondary and lesser sponsors and the primary as well as secondary and lesser products or services as well as any themes the make up the promotion. The secondary and lesser products or services can be products or services of the primary sponsor other than the primary product or service.

In one embodiment, the promotion in accordance with the invention can be sponsored by a third party organization, herein referred to as a host, that is not also the sponsor of a product or service being promoted. In this embodiment, the host selects the primary sponsor and either the host or the primary sponsor (or both) selects the primary product or service. The host or the primary sponsor (or both) also selects the secondary sponsors and the secondary products or services. Some or all of the secondary (and lesser) products or services can also be products or services of the primary sponsor.

Once the primary product(s) or service(s) are identified and selected, the relationship between the primary product or service and the secondary (and lesser) products or services can also be identified and selected so that secondary sponsors and secondary products or services can be selected consistent with the way the primary sponsor intends to promote the primary product or service. The relationship can be based upon a common theme of the interactive cross-branding promotion or the relationship can be uniquely defined for each secondary product or service selected. After the common theme or the individual relationships are defined, the cross-branding promotion can be designed. Alternatively, the theme and/or design of the cross-branding promotion can be chosen at the same time as the primary product or service has been chosen, after which the secondary sponsors and secondary products or services are selected. The design, difficulty and theme of the interactive cross-branding promotion can be anything that the primary sponsor chooses it to be and can be as complicated as a graphics intense video game or as simple as answering a few trivia questions. The design, difficulty and theme of the promotion can also be a combination of the complex and simple. The degree of complexity and difficulty can also be tailored to complement the primary sponsor's promotional objectives.

In an alternative embodiment, an interactive cross-branding promotion in accordance with the present invention can include a plurality of sponsors in which the selected products or services of each sponsor are intended to enhance the value, image or consumer desirability of at least one of the other products or services being promoted. In this embodiment, the products or services are not ranked or classified as primary or secondary (or tertiary), and each presentation that makes up the promotion can be the responsibility of the sponsor of the product that is being promoted (by a given presentation). The only limitation imposed on each presentation is that the presentation must be designed to enhance the value, image or consumer desirability of at least one of the other products or services being promoted. Alternatively, the promotion can be sponsored by a third party organization or host as described above. In addition, the host can be a third party selected by one or more of the product or service sponsors or the host can be made up of a consortium of the product or service sponsors.

In accordance with the invention, some or all of the products or services promoted can be related to each other. For example, at least one product or service can be related to at least one other product or service promoted in the promotion in a certain way or all the products and services can be related to each other in the same way or in different ways. There are many ways in which products or services can be related to other products or services, for example, the products, services or brands can be directly related to each other or the products, services or brands can be related by a common theme.

Examples of how products, services or brands can be directly related to each other include: one product or service is used in conjunction with another (e.g., Spalding tennis balls & Head tennis racquets); one product or service enhances the aesthetic value of another (e.g., Pledge furniture polish & Ethan Allen furniture); one product or service facilitates the use of another. (e.g., Salomon ski boots & K2 skis); one product or service enhances the capacity or strength of another (e.g., I-Omega Zip drive & Dell computer); one product or service is an accessory to another (e.g., OnStar & Cadillac satellite navigation system); one product or service is an integral component of another (e.g., Rolls Royce jet engine & Boeing airplane); one product or service is used to access another (e.g., Loews movie theater & MGM Grand Movie); several products are owned by or services are provided by the same corporation (e.g., Chrysler Jeep & Mercedes Benz).

Examples of how products, services or brands can be related by a common theme or product sponsor include: all products or services owned by a same corporation (e.g., Pepsico, Inc.—Pepsi-cola soft drink, Doritos nacho chips, Tropicana orange juice, Dole fruit juice); all products or services are used in a common setting (e.g., Beach—Oakley sun glasses, Frisbee, Budweiser beer, Wise potato chips); all products or services are used in a common activity (e.g., Fishing—Orivis fly rod, Cortland fly line, North bay canoe company, cutters insect replant ); all products or services appeal to a specific group of people who share a specific set of common characteristics (e.g., Balding men—hair growth products, wigs, toupee, hats); all products or services are used to achieve a common purpose (e.g., look attractive—Maybelline lipstick, oasis tanning salons, GNC vitamins, Gold's gym, Bliss spa); all products or services are used to achieve a common goal (e.g., Plan perfect wedding proposal—Executive Limousine service, Zagat restaurant guide, Tiffany Jeweler, FTD florist); all products or services are used to achieve a common action (e.g., Take a vacation—Liberty Travel Agent, Delta Airlines, CNN weather, American Express travelers checks); all products or services are used to achieve a common objective (e.g., Loose weight—weight watchers, Nike, sporting goods store, GNC health food,); all products or services are used to achieve a common image (e.g., Environmentally friendly—Green peace, NYC recycle program, Body Shop cosmetics, Save The Earth foundation, Wave Rider foundation); all products or services are used to achieve a common feeling (e.g., In the holiday spirit—Hallmark, LL Bean, k2 skis, Butterball Turkey, Christmas shop); all products or services are used to achieve a common mood (e.g., Patriotic—Republican Political Party, Statue of Liberty, Mount Rushmore, US Navy, Arlington National Cemetery); all products or services are used to achieve a common culture (e.g., Irish—Folk Dance music, Blarny woolen mills hand knit sweaters, Celtic Origins genealogical society, Barry Tea, Coosen Tavern cooking recipes, Celtic historical society, Gunnies beer)

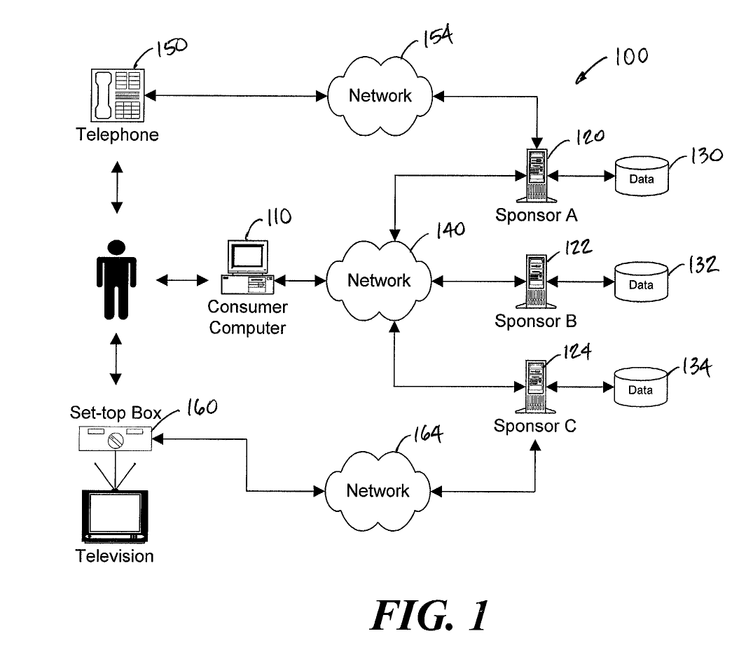

FIG. 1 shows a system for providing an interactive cross-branding promotion in accordance with the present invention. The system 100 includes a consumer computer 110 and one or more sponsor computers 120, 122, 124 connected to each other via a network 140 such as the Internet. The sponsor computers 120, 122, 124 can include a web server in order to provide web pages to a consumer at consumer computer 110, or any other web-enabled device (e.g., cell phone, web TV, or PDA). Content including text, graphics, audio and video stored in data storage 130, 132, 134 at one or more sponsor computers 120, 122, 124 can be sent to the consumer computer 110 via the network 140. The consumer at consumer computer 110 can interact with one or more of the sponsor computers 120, 122, 124 by selecting hyperlinks, selecting radio button controls or filling in forms in the web pages presented to the consumer. Alternatively, the consumer can interact via a separate interactive medium, such as a telephone 150 or interactive set-top cable box 160. The telephone 150 can, using for example IVR (DTMF or Touch Tone) responses or speech recognition, allow the consumer to interact with one or more of the sponsor computers 120, 122, 124 over network 154 which can be a private network such as a public switched telephone network (PSTN) or other private voice and data network. The set-top cable box 160 can, using for example IVR (DTMF or Touch Tone) responses or other well known data signaling techniques, allow the consumer to interact with one or more of the sponsor computers 120, 122, 124 over network 164 which can be a private network such as the a cable television network or other private voice and data network.

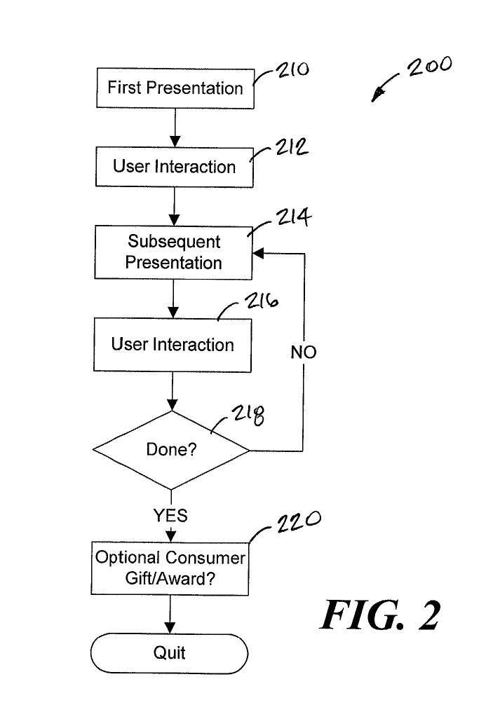

FIG. 2 shows a flow chart of a method for providing an interactive cross-branding promotion in accordance with the present invention. The method 200 starts with the presentation of a first interactive presentation to a consumer in step 210. The first presentation can provide an introduction to the promotion, identify the theme, the primary or first sponsor and/or the primary or first product or service to be promoted. The first presentation can also request consumer information, such as the consumer's name, address, email address, nickname or login name, if this information was not previously obtained. The first interactive presentation also requires some form of input, feedback or response from the consumer to continue the promotion. The consumer interaction can take the form of selecting a hyperlink, selecting a radio button or check box or inputting of information (e.g., consumer's age, answer to a trivia question, favorite color, music, food, beverage or vacation spot). The consumer interaction or response is entered at step 212. The consumer is presented with a second (or subsequent) presentation at step 214. The second presentation can be similar to the first in that it relates to the primary or first product or service or the second presentation can relate to a secondary or second product or service to be promoted. The second presentation also require some form of input, feedback or response from the consumer to continue the promotion. The consumer interaction or response is entered at step 216. At step 218, the process determines whether there are additional presentations to be presented to the consumer. If there are additional presentations to be presented to the consumer, the process continues the loop of steps 214, 216 and 218 until the last presentation is made or the consumer terminates their participation. If the last presentation is presented (e.g., there are no more presentations or the consumer voluntarily exited the promotion), the promotion continues to step 220. In an option step 220, the consumer who participated in the promotion, to the satisfaction of the sponsor or sponsors, can be given a prize or award.

In one example, consumers are lead through a sequence of web pages within a primary sponsor's web site and/or a sequence of web sites and/or web pages of the primary and secondary sponsors. The primary product or service is promoted in some manner on the primary sponsor's web site or web page. The secondary products and/or services are promoted in some manner on the secondary sponsors' web sites or web pages, preferably in conjunction with the primary product or service. To entice consumers into passing through an entire cross-branding promotion, incentives of some type (e.g., cash prizes, product giveaways, product discounts) can be offered or awarded. These incentives can be offered or awarded only at the completion of the cross-branding promotion and/or throughout the promotion at various points chosen by the primary and/or secondary sponsors. Depending upon the promotional theme and design, interactive clues, puzzles, games and races can be used with or in lieu of awards throughout and/or at the end of the cross-branding promotion as a form of online entertainment to entice consumers to complete the promotion by, for example, visiting the entire sequence of web pages making up the promotion.

For example, promotional contestants (consumers) can begin the process of entering into the interactive cross-branding promotion by visiting any sponsor's web site (or a host's website) or an alternately designed web site on the Internet, which describes the promotion. Prior to entering the promotion, consumers may be asked to read and agree to an online promotional agreement, which sets forth the promotional rules, regulations, prizes and disclaimers. Consumers may also be asked to complete an online profile questionnaire (whether or not they have not already done so) that may be used for marketing purposes during and after the promotion.

The consumer can move through the promotion via Internet browsers and hyperlinks to view and interact with the various web pages in the promotional sequence. This process is continued until the contestant has completed or abandoned the promotion. Each web page can display any sponsor's products or services (e.g., the primary sponsor's products or services or a secondary sponsors' products or services), and a promotional icon that can transport/hyperlink the contestant to the next web page. Regardless of the design of the promotion, the type and degree of interaction required at each stage or web page of the promotion is up to the sponsors of the promotion.

### EXAMPLES

### Example 1

In this example, contestants are brought through a series of web pages that expose them to the products or services of the primary and secondary sponsors. This exposure enhances the primary product's image by cross selling it with secondary products that re-enforce the image, value or consumer desirability of the primary product or service.

The following example of an interactive cross-branding promotion is in the form of a trivia question based contest in which prizes are awarded at the completion of the contest/promotion based on sponsor determined criteria.

| | |
|---|---|
| Primary Sponsor: | Daimler Chrysler |
| Primary Product: | Jeep Grand Cherokee XLS |
| Promotional Theme: | Road Rally across the Internet (just follow the clues) |
| First Prize: | New Jeep Grand Cherokee XLS |
| Other Prizes: | Patagonia Mountain Climbing Gear & |
| | K2 Ski Equipment |
| Media Style: | Multiple choice trivia questions with video and |
| | automated graphics |

### Secondary Sponsors, Products and Services

| Secondary Sponsors | Secondary Products & Services |
|---|---|
| Patagonia | Mountain climbing gear |
| USDA Forest Service | Colorado's Chimney Rock Preservation |
| LL Bean | Fly fishing equipment |
| USDA Forest Service | Colorado's Lemon Lake/Reservoir |
| K2 | Snowboard equipment |
| Jackson Hole Mountain Resort | Ski and snowboard facilities |
| Treck | Mountain bikes |
| Jackson Hole Mountain Resort | Summer mountain bike trails |
| Teva | River-rafting sandals |
| Turtle River Rafting Company | Rafting trips in California |

### Web Page Sequence

1. Contestant arrives at the Jeep Promotional web page.

2. Contestant reads and agrees to the promotional contest rules and disclaimers. The rules explain that contestants must find a series of Jeep Promotion icons, select them (e.g., by clicking on them) and correctly answer trivia questions related to destinations within the U.S.A. associated with outdoor activities.

3. Contestant completes the customer profile.

4. Contestant begins the promotional contest by selecting the starting icon/hyperlink.

5. Contestant views a short video displaying the attributes of the Jeep Grand Cherokee XLS and selects the promotional icon to move to the next stage or page of the promotion.

6. Contestant is taken to Patagonia's mountain climbing gear web page.

7. Contestant selects the Jeep Promotion icon and is asked one or more trivia questions

a. By providing the correct answer(s), a hyperlink takes the contestant to the next page in the promotional contest (go to step #8).

b. By providing a wrong answer, a hyperlink takes the contestant to a different page within Patagonia's web site where the trivia question(s) are again presented to the contestant. This process is repeated until all correct answers are provided at which point the contestant is taken to the next page of the promotion. Alternatively, the process could continue until a preset number of failures occur, until each web page within the sponsor's web site has been visited once, or the happening of any other event determined by the sponsors.

8. Contestant is taken to the USDA Forest Service's Chimney Rock Mountain Preservation web page. Contestant selects the Jeep Promotion icon and is asked one or more trivia questions.

a. By providing the correct answer(s), a hyperlink takes the contestant to the next page in the promotional contest (go to step #9).

b. By providing a wrong answer, a hyperlink takes the contestant to a different page within the USDA Forest Service's web site where the trivia question(s) are again presented to the contestant. This process is repeated until all correct answer are provided at which point the contestant is taken to the next page of the promotion. Alternatively, the process could continue until a preset number of failures occur, until each web page within the sponsors web site has been visited once, or the happening of any other event determined by the sponsors.

9. Contestant is taken to the LLB fly fishing equipment web page. Contestant selects the Jeep Promotion icon and is asked one or more trivia questions.

a. By providing the correct answer(s), a hyperlink takes the contestant to the next page in the promotional contest (go to step #10).

b. By providing a wrong answer, a hyperlink takes the contestant to a different page within the LL Bean's web site where the trivia question(s) are again presented to the contestant. This process is repeated until all correct answers are provided at which point the contestant is taken to the next page of the promotion. Alternatively, the process could continue until a preset number of failures occur, until each web page within the sponsors web site has been visited once, or the happening of any other event determined by the sponsors

10. Contestant is taken to the USDA Forest Service Lemon Lake/Reservoir web page.

Contestant selects the Jeep Promotion icon and is asked one or more trivia questions.

a. By providing the correct answer(s), a hyperlink takes the contestant to the next page in the promotional contest (go to step #11).

b. By providing a wrong answer, a hyperlink takes the contestant to a different page within the USDA Forest Service web site where the trivia question(s) are again presented to the contestant. This process is repeated until all correct answers are provided at which point the contestant is taken to the next page of the promotion. Alternatively, the process could continue until a preset number of failures occur, until each web page within the sponsors web site has been visited once, or the happening of any other event determined by the sponsors.

11. Contestant is taken to the K2 snow board equipment web page. Contestant selects the Jeep Promotion icon and is asked one or more trivia questions.

a. By providing the correct answer(s), a hyperlink takes the contestant to the next page in the promotional contest (go to step #12).

b. By providing a wrong answer, a hyperlink takes the contestant to a different page within the K2 web site where the trivia question(s) are again presented to the contestant. This process is repeated until all correct answers are provided at which point the contestant is taken to the next page of the promotion. Alternatively, the process could continue until a preset number of failures occur, until each web page within the sponsors web site has been visited once, or the happening of any other event determined by the sponsors.

12. Contestant is taken to the Jackson Hole Mountain Resort ski and snowboard web page. Contestant selects the Jeep Promotion icon and is asked one or more trivia questions.

a. By providing the correct answer(s), a hyperlink takes the contestant to the next page in the promotional contest (go to step #13).

b. By providing a wrong answer, a hyperlink takes the contestant to a different page within the Jackson Hole Mountain Resort web site where the trivia question(s) are again presented to the contestant. This process is repeated until all correct answers are provided at which point the contestant is taken to the next page of the promotion. Alternatively, the process could continue until a preset number of failures occur, until each web page within the sponsors web site has been visited once, or the happening of any other event determined by the sponsors.

13. Contestant clicks on the Trek Mountain Bike web page. Contestant selects the Jeep Promotion icon and is asked one or more trivia questions.

a. By providing the correct answer(s), a hyperlink takes the contestant to the next page in the promotional contest (go to step #14).

b. By providing a wrong answer, a hyperlink takes the contestant to a different page within the Trek web site where the trivia question(s) are again presented to the contestant. This process is repeated until all correct answers are provided at which point the contestant is taken to the next page of the promotion. Alternatively, the process could continue until a preset number of failures occur, until each web page within the sponsors web site has been visited once, or the happening of any other event determined by the sponsors.

14. Contestant is taken to the Jackson Hole Mountain Resort summer mountain bike trail web page. Contestant selects on the Jeep Promotion icon and is asked several trivia questions.

a. By providing the correct answer(s), a hyperlink takes the contestant to the next page in the promotional contest (go to step #15).

b. By providing a wrong answers, a hyperlink takes the contestant to a different page within the Jackson Hole Mountain Resort web site where the trivia question(s) are again presented to the contestant. This process is repeated until all correct answers are provided at which point the contestant is taken to the next page of the promotion. Alternatively, the process could continue until a preset number of failures occur, until each web page within the sponsors web site has been visited once, or the happening of any other event determined by the sponsors.

15. Contestant is taken to the Teva river rafting sandal web page. Contestant selects the Jeep Promotion icon and is asked one or more trivia questions.

a. By providing the correct answer(s), a hyperlink takes the contestant to the next page in the promotional contest (go to step #16).

By providing a wrong answer, a hyperlink takes the contestant to a different page within a Teva web site where the trivia question(s) are again presented to the contestant. This process is repeated until all correct answers are provided at which point the contestant is taken to the next page of the promotion. Alternatively, the process could continue until a preset number of failures occur, until each web page within the sponsors web site has been visited once, or the happening of any other event determined by the sponsors.

16. Contestant is taken to the Turtle River Rafting Company's rafting trips in California web page. Contestant selects the Jeep Promotion icon and is asked one or more trivia questions.

a. By providing the correct answer(s), a hyperlink takes the contestant to the next page in the promotional contest (go to step #17).

b. By providing a wrong answer, a hyperlink takes the contestant to a different page within the Turtle River Rafting Company's web site where the trivia question(s) are again presented to the contestant. This process is repeated until all correct answers are provided at which point the contestant is taken to the next page of the promotion. Alternatively, the process could continue until a preset number of failures occur, until each web page within the sponsors web site has been visited once, or the happening of any other event determined by the sponsors.

17. Contestant is taken to the final page of the Jeep promotional contest and advised of contest ranking and prizes.

### Example 2

The following example of an interactive cross-branding promotion is in the form of a survey in which prizes are awarded at the completion of the survey/promotion based on sponsor determined criteria.

| | |
|---|---|
| Primary Sponsor: | Anheuser Busch Inc. |
| Primary Product: | Budweiser beer |
| Promotional Theme: | “The Perfect Summer Party” |
| First Prize: | Win the perfect summer party catered by Budweiser |
| | for you and 100 of your friends |
| Other Prizes: | Ron Jon surfboards, |
| | LL Bean hammocks |
| | Atlantic Records compact disks, |
| | Club Planet.com night club passes |
| | Kansas City Steak gift certificates |
| | Pool Lobster gift certificates |
| | Kentucky Fried Chicken gift certificates |
| | ESPN baseball caps and world series tickets |
| | REI backpacks |
| | Columbia TriStar movie tickets |
| Media Style: | Animation and audio are used to create the |
| | contestant's perfect summer party. Each |
| | response to a survey question adds a new |
| | animated an/or audio element to a composite |
| | picture which occupies part of the contestants |
| | computer screen. |

### Secondary Sponsors, Products and Services

| Secondary Sponsors | Secondary Products & Services |
|---|---|
| Ron Jon | Surfing gear and swimsuits |
| LL Bean | Backyard furniture and accessories |
| Atlantic Records | Music |
| Club Planet.com | Night club information |
| Kansas City Steaks | Steaks |
| Pool Lobster | Lobsters |
| Kentucky Fried Chicken | Chicken |
| ESPN | Sports information |
| REI | Outdoor gear |
| Columbia TriStar | Movies |

### Web Page Sequence

1. Contestant arrives at the Budweiser Promotional web page.

2. Contestant reads and agrees to the promotional contest rules and disclaimers. The rules explain that contestants must answer a series of survey questions (e.g., by clicking on them).

3. Contestant completes customer profile that includes providing the following information:

Gender, age and email address.

4. Contestant begins the promotional contest by selecting the starting icon/hyperlink.

5. The contestant is asked the first question: The perfect summer party takes place?

6. The contestant answers the question by clicking on the his/her preferred answer/hyperlink:

A) “At the Beach”—This answer causes two things to happen:

1) It takes the contestant to Ron Jon's surfboard/swimsuit web page.

2) An animated image of the Budweiser logo with people at a party in a beach setting appear on part of the contestants computer screen.

B) “In a Backyard”—This answer causes two things to happen:

1) It takes the contestant to the LL Bean backyard furniture web page.

2) An animated image of the Budweiser logo with people at a party in a backyard setting appear on part of the contestants computer screen.

C) “In a Nightclub ”—This answer causes two things to happen:

1) It takes the contestant to the Club Planet.com web page.

2) An animated image of the Budweiser logo with people at a party in a nightclub setting appear on part of the contestants computer screen.

7. The contestant is asked the second question: At the perfect summer party you are listening to?

8. The contestant answers the question by clicking on the his/her preferred answer/hyperlink:

D. “Jimmy Buffet”—This answer causes two things to happen

1) It takes the contestant to the Jimmy Buffet web page.

2) Music by Jimmy Buffet accompanies the animated images which continue to occupy part of the contestants computer screen.

E. “Hootie & the Blowfish”—This answer causes two things to happen:

1) It takes the contestant to the Hootie & the Blowfish web page.

2) Music by Hootie and the Blowfish accompanies the animated images which continue to occupy part of the contestants computer screen.

F. “Puff Daddy”—This answer causes two things to happen:

1) It takes the contestant to the Puff Daddy web page.

2) Music by Puff Daddy accompanies the animated images which continue to occupy part of the contestants computer screen.

9. The contestant is asked the 3rd question: At the perfect summer party you are eating with?

10. The contestant answers the question by clicking on the his/her preferred answer/hyperlink:

G. Steak Knifes—This answer causes two things to happen:

1) It takes the contestant to the Kansas City Steaks.com web page.

2) Images of people grilling steak are added to the animated party images which continue to occupy part of the contestants computer screen.

H. Your Fingers—This answer causes two things to happen:

1) It takes the contestant to the Kentucky Fried Chicken web page.

2) Images of people eating chicken are added to the animated party images which continue to occupy part of the contestants computer screen.

I. Bibs—This answer causes two things to happen:

1) It takes the contestant to the Pool Lobster web page.

2) Images of people cooking lobsters are added to the animated party images which continue to occupy part of the contestants computer screen.

11. The contestant is asked the 4th question: At the perfect summer party the talk is about

12. The contestant answers the question by clicking on the his/her preferred answer/hyperlink:

J) Sports—This answer causes two things to happen:

1) It takes the contestant to the ESPN web page.

2) Images and sounds of people talking about sports are added to the animated party images which continue to occupy part of the contestants computer screen.

K) The Great Outdoors—This answer causes two things to happen:

1) It takes the contestant to the REI web page.

2) Images and sounds of people talking about the great outdoors are added to the animated party images which continue to occupy part of the contestants computer screen.

L. Summer Movies—This answer causes two things to happen:

1) It takes the contestant to the Columbia TriStar movie web page.

2) Images and sounds of people talking about movies are added to the animated party images which continue to occupy part of the contestants computer screen.

13. The contestant is asked to complete the promotion by clicking on a hyperlink to the Budweiser promotional conclusion page.

14. The Budweiser promotional conclusion page informs the contestant he/she is eligible for the grand prize drawing and may also be awarded one or more prizes from the secondary sponsors.

15. The Budweiser promotional conclusion page offers the contestant the opportunity to receive future solicitations, and offers from the primary and secondary sponsors.

16. End.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A method for promoting a product or service comprising the steps of:
a) identifying a first sponsor;
b) identifying a first product or service;
c) identifying a second sponsor;
d) identifying a second product or service;
e) designing an interactive cross-branding promotion; and
f) implementing an interactive cross-branding promotion.

2. A method for promoting a product or service according to claim 1 wherein said first sponsor is a primary or secondary sponsor.

3. A method for promoting a product or service according to claim 1 wherein said second sponsor is a primary sponsor.

4. A method for promoting a product or service according to claim 1 further comprising the steps of:
a) identifying a third sponsor.

5. A method for promoting a product or service according to claim 4 further comprising the steps of:
a) identifying a third product or service.

6. A method for promoting a product or service according to claim 4 wherein said third sponsor is a primary sponsor.

7. A method for promoting a product or service according to claim 4 wherein said third sponsor is a secondary sponsor.

8. A method for promoting a product or service according to claim 4 wherein said third sponsor is a tertiary sponsor.

9. A product or service promotion comprising:
a first sponsor;
a first product or service;
a second sponsor;
a second product or service;
an interactive presentation promoting said first product or service; and
an interactive presentation promoting said second product or service;
wherein said first product or service is related to said second product or service.

10. A product or service promotion according to claim 10 further comprising:
a third sponsor;
a third product or service; and
an interactive presentation promoting said third product or service;
wherein said third product or service is related to either said first product or service or said second product or service.

11. A method of promoting a product or service comprising the steps of:
a) presenting a first interactive presentation to a consumer;
b) receiving input from said consumer [concerning said first interactive presentation];
c) presenting a second interactive presentation to said consumer, said second interactive presentation being related to said first interactive presentation;
d) receiving input from said consumer [concerning said second interactive presentation].

12. A method according to claim 11, further comprising the steps of:
a) presenting a third interactive presentation to said consumer, said second interactive presentation being related to said first interactive presentation or said second interactive presentation;
b) receiving input from said consumer [concerning said third interactive presentation].

13. A method according to claim 11 wherein
said first interactive presentation promotes a first product or service and said second interactive presentation promotes a second product or service; and
said first interactive presentation is related to said second interactive presentation in that said first product or service can be used in conjunction with said second product or service.

14. A method according to claim 12 wherein
said first interactive presentation promotes a first product or service, said second interactive presentation promotes a second product or service and said third interactive presentation promotes a third product or service; and
said third interactive presentation is related to either said first interactive presentation or said second interactive presentation in that said third product or service can be used in conjunction with either said first product or service or said second product or service.

15. A system for promoting a product or service comprising;
means for presenting a first interactive presentation to a consumer means for receiving input from said consumer [concerning/in response to said first interactive presentation];
means for presenting a second interactive presentation to said consumer, said second interactive presentation being related to said first interactive presentation;
means for receiving input from said consumer [concerning/in response to said second 8 interactive presentation].
